(19) United States
(12) Patent Application Publication
(10) Pub. No.: US 2025/0237261 A1
(43) Pub. Date: Jul. 24, 2025

(54) INSULATED BEARING AND METHOD OF MANUFACTURING THE SAME

(71) Applicant: Aktiebolaget SKF, Göteborg (SE)

(72) Inventors: Yanqin GAO, Shanghai (CN); Hongyan WANG, Shanghai (CN); Zhonghua ZOU, Shanghai (CN); Hongyuan AN, Shanghai (CN); Thea FAN, Kunming (CN)

(21) Appl. No.: 19/017,877

(22) Filed: Jan. 13, 2025

(30) Foreign Application Priority Data
Jan. 18, 2024 (CN) 202410076835.9
Oct. 8, 2024 (CN) 202411398754.7

(51) Int. Cl. F16C 19/52; F16C 33/62

(52) U.S. Cl. CPC F16C 19/52; F16C 33/62; F16C 2202/30; F16C 2208/04; F16C 2208/52; F16C 2208/60; F16C 2220/04

(57) ABSTRACT

An insulating bearing includes an outer ring, an inner ring, and rolling elements arranged between the outer and inner rings. One of the outer and/or inner ring is an insulated ring having a body and an insulating layer overmolded on the body. The insulating layer has a dielectric constant lower than 5 @ 1 MHz, more preferably lower than 4 @ 1 MHz, more preferably lower than 3.5 @ 1 MHz. The present disclosure also provides a method for manufacturing an insulating bearing. The method includes overmolding the insulating layer so that the weld seam of the insulating layer after overmolding avoids the main force-loading area of the insulated ring and/or is formed where the thickness of the insulating layer is the maximum. By overmolding, the insulating layer provides sufficient insulation even when there is high voltage and high frequency current, thereby preventing electrical corrosion of the bearing.

### CROSS-REFERENCE TO RELATED APPLICATIONS

This application claims priority to Chinese Application No. 202410076835.9, filed Jan. 18, 2024 and to Chinese Application No. 202411398754.7, filed Oct. 8, 2024, the entireties of which are hereby incorporated by reference.

### FIELD

The present disclosure relates to an insulated bearing and a manufacturing method thereof.

### BACKGROUND

Bearings are widely used in various types of equipment. Different application fields often impose different requirements on bearings.

Taking electrical equipment such as electric vehicles as an example, since their drive motor shafts, transmission shafts, etc. require the use of bearings, these types of bearings work in a charged environment. Moreover, since the charging of electric vehicles is increasingly pursuing increase of the charging voltage to shorten the charging time, the bearings on the motor shaft are also exposed to higher and higher voltage environments. When current passes through the bearings, electrical corrosion will occur on the bearings.

Therefore, the prior art provides to electrically insulate the bearings to prevent current from flowing through the bearings. Common insulation solutions comprise electrically insulating at least one of the outer ring, rolling elements, and inner ring of the bearing. For example, one solution is to apply insulating coating on the outer ring, the inner ring or the rolling elements, or even to manufacture the rolling elements directly from insulating material such as ceramic.

A further solution is to mold an insulating layer on the outside of the outer/inner ring of the bearing, which insulating layer is overmolded on the outer circumferential face opposite to the raceway and the axial end face. However, since the bearing tends to move at high speed and under high load, although the insulating layer is overmolded on the outer ring/inner ring, after a long time of operation, the insulating layer inevitably undergoes axial and/or circumferential movement, which in turn causes damage to the insulating layer and affects the insulation of the entire bearing.

In addition, the prior art, whether using ceramic coatings or over-molded insulation, provides unsatisfactory insulation protection in the environment of high voltage or high frequency current.

Therefore, there is a need in the art for a technical solution that can effectively provide insulation and can effectively prevent movement of the insulating layer.

### SUMMARY

In response to the above-mentioned problems and needs, the present disclosure proposes a new technical solution, which solves the above problems and brings other technical effects by adopting the following technical features.

The disclosure proposes an insulating bearing, comprising an outer ring, an inner ring, and rolling elements arranged between the outer ring and the inner ring, wherein at least one of the outer ring and the inner ring is configured as an insulated ring comprising a body and an insulating layer overmolded on a surface of the body, wherein the insulating layer has a dielectric constant lower than 5 @ 1 MHz, more preferably lower than 4 @ 1 MHz, more preferably lower than 3.5 @ 1 MHZ.

The present disclosure also provides a method for manufacturing an insulating bearing as described above, which comprises: a gate used for an injection molding machine for overmolding the insulating layer is arranged so that the weld seam of the insulating layer after overmolding avoids the main force-loading area of the insulated ring and/or is formed in the insulating layer where the thickness of the insulating layer is maximum.

The present disclosure provides improved insulation properties for bearings operating in electrical environments, especially under high voltage, high frequency current conditions encountered by bearings, present disclosure provides that the rings (inner and/or outer rings) is overmolded with an insulating layer having a dielectric constant lower than 3.5 @ 1 MHz with the insulating layer being preferably made from a polymer alloy, and its mechanical properties and thermal conductivity are preferably further optimized by adding glass fibers/thermal conductive materials. Therefore, the present disclosure provides an insulated bearing with good insulation and suitable for harsh working environments.

### BRIEF DESCRIPTION OF DRAWINGS

FIG. 1 is a cross-sectional view of an insulated ring according to a first preferable embodiment of the present disclosure;

FIG. 2 is a partial perspective view of an insulated ring and an enlarged view of a knurling structure according to a first preferable embodiment of the present disclosure;

FIG. 3 is a cross-sectional view of an insulated ring according to a second preferable embodiment of the present disclosure;

FIG. 4 is an enlarged view of a knurling structure in an insulated ring according to a second preferable embodiment of the present disclosure;

FIG. 5 is a cross-sectional view of an insulated ring according to a third preferable embodiment of the present disclosure;

FIG. 6 is an enlarged view of a knurling structure in an insulated ring according to a third preferable embodiment of the present disclosure;

FIG. 7 is a cross-sectional view of an insulated ring according to a fourth preferable embodiment of the present disclosure;

FIGS. 8A and 8B are cross-sectional views of an insulated ring according to a fifth preferable embodiment of the present disclosure;

FIG. 9 is a cross-sectional view of an insulated ring according to a modification of the present disclosure;

FIG. 10 is a schematic view for explaining the formation of weld seam of the insulating layer;

FIG. 11 is a schematic view of the position of each gate in the manufacture method of the insulated bearing according to a preferable embodiment of the present disclosure.

### DETAILED DESCRIPTION

In order to make the purpose, technical solution and advantages of the technical solution of the present disclosure clearer, the technical solution of the embodiment of the present disclosure will be described clearly and completely in the following with the attached drawings of specific embodiments of the present disclosure. Like reference numerals in the drawings represent like components. It should be noted that a described embodiment is a part of the embodiments of the present disclosure, not the whole embodiments. Based on the described embodiments of the present disclosure, all other embodiments obtained by those skilled in the field without creative labor fall into the scope of protection of the present disclosure.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by those skilled in the field to which this disclosure belongs. The terms “first”, “second” and similar terms used in the specification and claims of the patent application of this disclosure do not indicate any order, quantity or importance, but are only used to distinguish different components. When the number of components is not specified, the number of components can be one or more. Similarly, terms such as “a/an”, “the” and “said” do not necessarily mean quantity limitation. Similar terms such as “including” or “comprising” mean that the elements or objects appearing before the terms cover the elements or objects listed after the terms and their equivalents, without excluding other elements or objects. Similar terms such as “installation”, “setting”, “connection” or “coupling” are not limited to physical or mechanical installation, setting and connection, but can comprise electrical installation, setting and connection, whether directly or indirectly. “Up”, “down”, “left” and “right” are only used to indicate the relative orientation relationship when the equipment is used or the orientation relationship shown in the attached drawings. When the absolute position of the described object changes, the relative orientation relationship may also change accordingly.

For the convenience of explanation, the direction of the rotation axis of the bearing is called an axial direction, and the direction perpendicular to the axial direction is called a radial direction. The term “inner/inward” refers to the direction toward the inside of the bearing, whereas the term “outer/outward” refers to the direction toward the outside of the bearing. Besides, same reference numbers refer to components with same or similar structure or function.

An insulated bearing according to the disclosure will be described below with reference to a preferable embodiment shown in the accompanying drawings. The insulated bearing according to the present disclosure comprising an outer ring, an inner ring (not shown), and rolling elements (not shown) provided between the outer ring and the inner ring, and the like. Usually, the outer ring and the inner ring are also collectively called rings. As mentioned before, in order to achieve the insulation for the bearing, at least one of the outer ring and the inner ring can be provided as an insulated ring. Therefore, the insulated ring of the insulated bearing according to the present disclosure comprises a body and an insulating layer overmolded on the surface of the body. In addition, the body further comprises: a raceway; an axial end face; a radial outer circumferential face disposed radially away from the raceway; wherein, a surface of the body comprises a groove and an insulating layer is overmolded and embedded in the groove, so that the groove effectively retains the insulating layer to prevent the insulating layer from moving axially/circumferentially. It should be understood that said surface may be any suitable surface or surfaces on the body of the insulated ring (this surface, of course, does not comprise the raceway surface), and the groove may be a groove(s) in any form and any number formed on the surface.

The insulated bearing according to the disclosure will be further described below with reference to preferable embodiments of the disclosure.

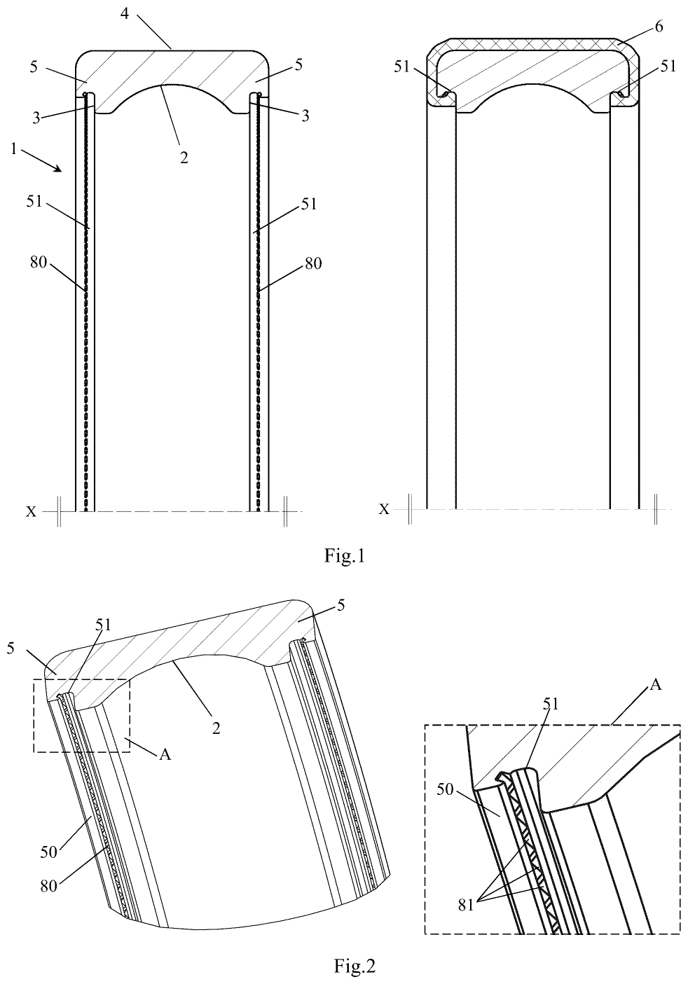

FIGS. 1 and 2 show a first preferable embodiment according to the present disclosure. This embodiment and the other embodiments described below all take the outer ring of the bearing as an example to introduce the features of the insulated bearing and its insulated ring according to the present disclosure.

Specifically, in a first preferable embodiment, an insulating layer 6 is overmolded on a surface of the body 1 of the insulated ring, wherein the dielectric constant of the insulating layer 6 is lower than 5 @ 1 MHz, more preferably lower than 4 @ 1 MHz, more preferably lower than 3.5 @ 1 MHz. It should be understood that the “surface” of the body 1 mentioned here may be any suitable surface, including, for example, an axial end face 3; a radially outer peripheral surface 4 disposed radially opposite the raceway 2; an axial flange 5 projecting axially outwardly with respect to the axial end face 3; and a radially inner circumferential surface 50 of the axial flange 5 facing the inside of the bearing (see FIG. 2). Therefore, the insulating layer 6 can be overmolded on part or all of these surfaces of the body 1 as desired.

By overmolding such insulating layer on the surface of the body of the insulated ring, the insulating layer provides sufficient insulation even when there is high voltage and high frequency current, thereby preventing electrical corrosion of the bearing.

In addition, it should be understand that although there are various known materials that have insulation properties and various measures that can achieve insulation effects, not all the insulating materials or insulation means can meet the requirements for the insulation performance of the bearings which operate under electrical environments, especially those environments with high frequencies and high voltage conditions. For example, although some materials have good insulating properties, said materials alone are not suitable for forming the insulating materials for bearings.

According to the inventor's further research, the inventor adopts a method of covering the bearing ring with an insulating layer and optimizing its dielectric constant by optimizing the ingredient ratio of the insulating layer to achieve the goal of the present disclosure.

Specifically, for blocking high-frequency current, if it is necessary to make the bearing have a smaller capacitance, the dielectric constant may be reduced, and thus the capacitance may be reduced.

If the inner and outer rings of the bearing are considered as a parallel plates capacitor, then according to the formula C=εS/d (where C is the capacitance of the parallel plates capacitor, ε is the dielectric constant of the medium between the plates, S is the area of the plates, and d is the distance between the plates), a material with a lower dielectric constant makes the bearing have a lower capacitance and therefore a better impedance. Moreover, according to the research of the inventor, when the dielectric constant of the insulating layer is lower than 5 @ 1 MHz, more preferably lower than 4 @ 1 MHz (more preferably lower than 3.5 @ 1 MHz), the above purpose of the present disclosure can be better achieved.

According to a preferable embodiment of the disclosure (as described later), the disclosure proposes an insulating layer formed, for example, by a polymer alloy, which comprises a continuous phase as a matrix. Two approaches are then adopted to further optimize its dielectric constant: firstly, introducing a low dielectric material as a dispersed phase (such as polyphenylene oxide (PPO) described below, with a dielectric constant of 2.7 @ 1 GHz); secondly, introducing glass fibers (such as D-glass fibers, with a dielectric constant of 4.1 @ 1 MHz; or quartz glass fibers, with a dielectric constant of 3.7-3.8 @ 1M Hz; or commonly used E-glass fibers (alkali-free glass fibers), with a dielectric constant of 6.5 @ 1 MHz).

In addition, in a more simplified embodiment, the insulating layer 6 can be formed, for example, by a polymer. The polymer is, for example, polyphenylene sulfide or aromatic nylon. Furthermore, the electrical properties and insulation properties of the insulating layer may be adjusted by adding glass fibers, etc.

Preferable embodiments of the present disclosure will be further described below based on the above concepts and principles.

As mentioned above, according to a preferable embodiment of the present disclosure, the insulating layer 6 may be formed, for example, by a polymer alloy, and the polymer alloy comprises a continuous phase and a dispersed phase.

Further preferably, in the case where the insulating layer 6 is formed, for example, by a polymer alloy, the continuous phase may be polyphenylene sulfide (PPS), or aromatic nylon (PPA, such as (PA9T, PA10T)), or a mixture of PPS and PPA. The continuous phase not only provides good insulating property, but also is suitable for providing sufficient load-bearing capacity, heat resistance, and corrosion resistance for the bearing operating under harsh and complicate environments.

Further preferably, in the polymer alloy, the content of the continuous phase may be 20-70 wt % (weight percentage), more preferably 40-60 wt %.

Further preferably, when the continuous phase comprises PPS, that is to say when the polymer alloy is formed from PPS alone or from a mixture of PPS and PPA, the PPS may be linear PPS and/or cross-linked PPS.

However, for some more strict insulation requirements, the continuous phase such as PPS, PPA still face a problem of having high dielectric constant. Therefore, more preferably, polyphenylene oxide (PPO) can be selected as the dispersed phase; preferably, the content of the dispersed phase is 5-25 wt % in the polymer alloy, more preferably 10-20 wt %. Since PPO usually has a lower dielectric constant, and thus, by adding PPO, the dielectric constant of the polymer alloy can be further adjusted, for example, the dielectric constant of the entire polymer alloy can be further reduced. And PPO has a high glass transition temperature, which can improve the dimensional stability of the material.

According to another preferable embodiment of the present disclosure, the insulating layer 6 may comprise glass fibers to adjust the mechanical properties of the entire insulating layer, such as to increase its mechanical strength, etc.

In addition, glass fibers usually have a higher dielectric constant, so for the purposes of the present disclosure and as mentioned above, the glass fibers may be preferably E-glass fibers, D-glass fibers and/or quartz glass fibers having lower dielectric constant.

Further preferably, in the polymer alloy, the content of the glass fiber is 20-60 wt %, more preferably 40-60 wt %.

According to a large number of research experiments on various insulating layer materials conducted by the inventor, it shows that as for bearing insulation application proposed by the present disclosure, when the dielectric constant of the insulating layer is lower than 5 @ 1MH, especially lower than 4 @ 1 MHz, an insulated bearing that meets electrical requirements can be obtained, and the insulating layer also has excellent mechanical properties to meet the operation requirements of the bearing. A comparison of some experiments is shown in the table below. In summary, by adjusting the material composition of the insulating layer so that its dielectric constant is 4 @ 1 MHz or lower while taking into account its mechanical properties, an insulated bearing more suitable for high frequency and high voltage applications can be obtained.

| | | | | | | Unnotched |
|---|---|---|---|---|---|---|
| | | | | | | charpy |
| | | Dielectric | Stretching | Bending | Bending | impact |
| | Insulating | Constant | Strength | Strength | Modulus | strength |
| | layer | @ 1 MHz | (Mpa) | (Mpa) | (Mpa) | (kJ/m²) |
| Exp. 1 | PPS + 50 | 5 | 170 | 260 | 14000 | 10 |
| | (E GF | | | | | |
| | And | | | | | |
| | fillers) | | | | | |
| Exp. 2 | PPA + | 4 | 170 | 260 | 13000 | 10 |
| | PPO + E | | | | | |
| | GF40 | | | | | |
| Exp. 2 | PPS + | 3.3 | 170 | 250 | 13000 | 10 |
| | PPO + D | | | | | |
| | GF40 | | | | | |
| Exp. 3 | PPA + | 3.4 | 190 | 300 | 15000 | 18 |
| | PPO + D | | | | | |
| | GF50 | | | | | |

According to a further preferable embodiment of the present disclosure, the insulating layer 6 may also comprise a thermal conductive material to adjust the thermal conductivity of the insulating layer. Especially for a bearing, a large amount of heat may be generated on the bearing due to its working environment and its own rotation. Therefore, improving the thermal conductivity of the insulating layer will better transfer the heat from the bearing.

Preferably, the thermal conductive material may be one or more of hexagonal boron nitride (h-BN), Al₂O₃, AlN, BeO, Si₃N₄, MgO and SiO₂.

In order to balance the above performance requirements, according to a preferable embodiment, the polymer alloy used to form the insulating layer may comprise 20-70 wt % of continuous phase, 5-25 wt % of dispersed phase, 20-60 wt % of glass fibers, and the remainder is thermal conductive material.

In addition, for bearings commonly used in electric drive assemblies of electric vehicles, in order to avoid electrical corrosion, thickness of the insulating layer 6 needs to be set between 0.2 mm and 2 mm, preferably between 0.4 mm and 1.2 mm.

The present disclosure provides improved insulation properties for bearings operating in electrical environments, especially under high voltage, high frequency current conditions encountered by bearings. present disclosure provides that the rings (inner and/or outer rings) is overmolded with an insulating layer having a dielectric constant lower than 5 @ 1 MHz with the insulating layer being preferably made from a polymer alloy, and its mechanical properties and thermal conductivity are preferably further optimized by adding glass fibers/thermal conductive materials. Therefore, the present disclosure provides an insulated bearing with good insulation and suitable for harsh working environments.

It should also be understood that although the insulating layer is described with respect to the first preferable embodiment shown in FIGS. 1-2, the insulating layer can also be applied to all other preferable embodiments described below, and therefore will not be repeated for each embodiment.

Referring to the preferable embodiment of FIGS. 1 and 2, the radially inner peripheral surface 50 comprises an inner radial groove 51 (which is generally recessed in the radial direction); wherein, the insulating layer 6 is overmolded on the radially outer circumferential face 4 and the axial flange 5, and the insulating layer 6 is embedded in said inner radial groove 51.

The left view of FIG. 1 shows a state when the insulating layer 6 is not overmolded, and the right view of FIG. 1 shows a state after the insulating layer 6 is overmolded.

It should be appreciated that the inner radial groove 51 may be formed by any suitable means, such as by machining like turning. The insulating layer 6 may be formed by any suitable overmolding means. According to the present disclosure, by providing such an inner radial groove 51, the molded insulating layer 6 is embedded in said inner radial groove, and thus movement of the insulating layer 6 in the axial direction X can be effectively prevented.

Referring further to FIG. 2, a partial perspective view of the insulated ring and an enlarged view of part A are shown. Further preferably, the inner radial groove 51 also comprises a knurling structure 80. The knurling structure 80 is machined by a hob cutter to form an uneven structure on the surface of the inner radial groove 51, that is, tens or even hundreds of small notches 81 are further machined in the inner radial groove 51. The knurling structure 80 may be, for example, a straight knurling. In addition, as shown in FIG. 2, the knurling structure 80 is formed on the side of the inner radial groove 51 farther from the raceway 2. However, according to actual needs, in a not-shown preferable embodiment, such knurling structure may be formed on the other side of the inner radial groove 51 closer to the raceway 2 and/or on bottom of the inner radial groove 51.

By machining the knurling structure 80 in the inner radial groove 51, the insulating layer 6 will be further embedded in the notches 81 of the knurling structure 80, thereby strengthening the connection between the insulating layer 6 and the inner radial groove 51. Moreover, since the knurling structures 80 are distributed along the circumferential direction of the body 1 of the ring, circumferential movement of the insulating layer 6 can be prevented.

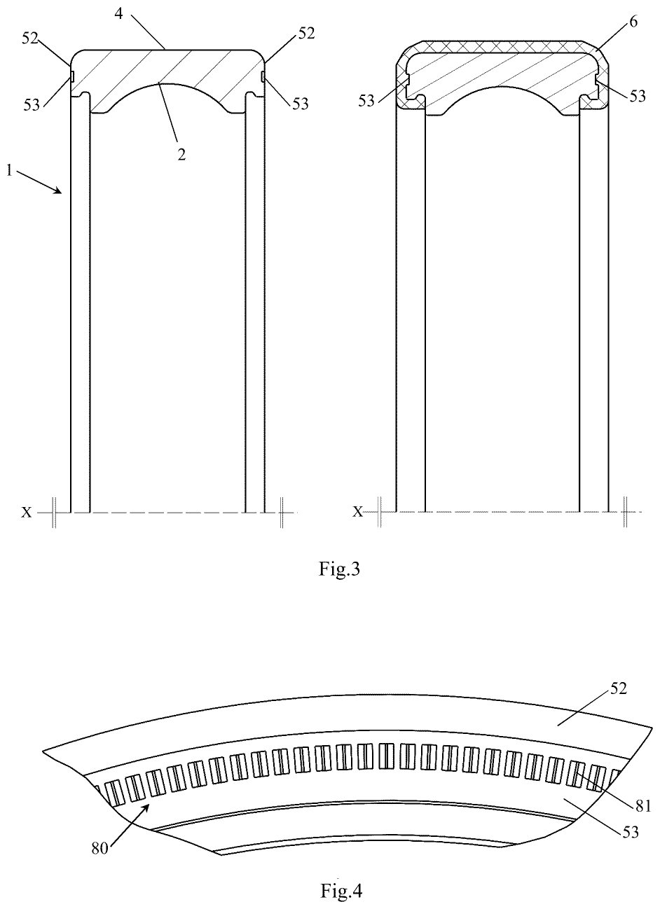

FIG. 3 shows a second preferable embodiment of the present disclosure. In this preferable embodiment, the axial flange 5 of the body 1 of the insulated ring may comprise an axial groove(s) 53 (which is substantially recessed in the axial direction) on its axial outer end face 52, and said insulating layer 6 is further embedded in said axial groove 53, as shown by the right view of FIG. 3.

Further preferably, as shown in FIG. 4, the axial groove 53 may also comprise a knurling structure 80, and the insulating layer 6 is further embedded in the notches 81 of the knurling structure 80 to further strengthen the connection between the insulating layer 60 and the axial groove 53, thereby preventing circumferential movement of the insulating layer 6. The knurling structure 80 is formed, for example, on the bottom of the axial groove 53. According to a not-shown embodiment, the knurling structure may be formed in side surfaces of the axial groove 53.

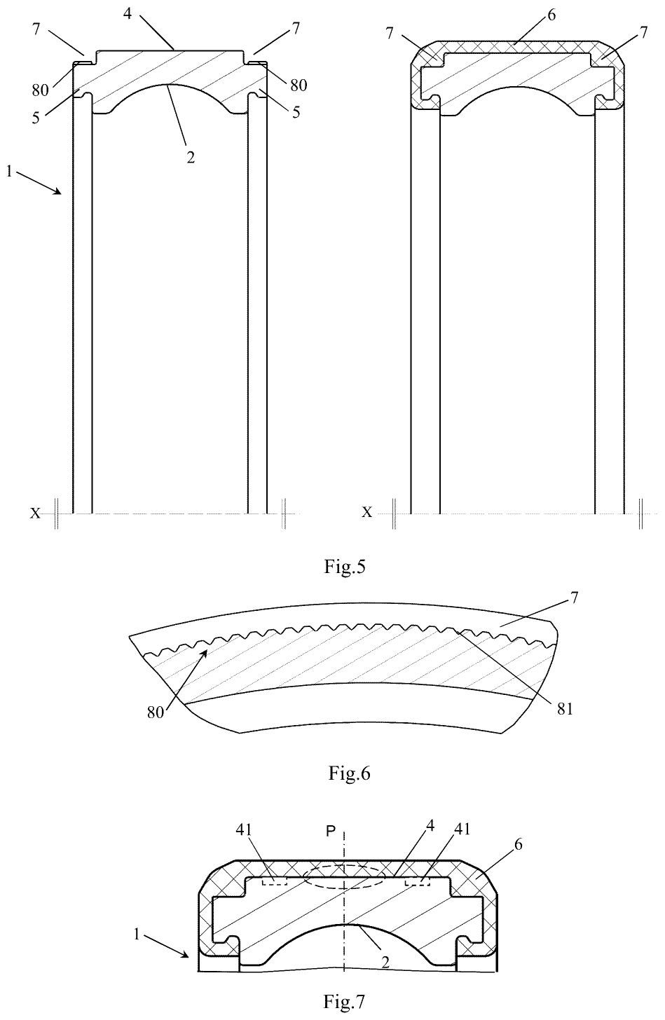

FIG. 5 shows a third preferable embodiment of the present disclosure, which is a further improvement to the first and/or second preferable embodiment. In this third preferable embodiment, the body 1 of the insulated ring further comprises a corner groove 7 provided at an intersection part between the radial outer circumferential face 4 and the axial flange 5. There are preferably two corner grooves 7, and the insulating layer 6 is further embedded in the corner grooves 7, as shown by the right view of FIG. 5. By providing such corner grooves 7, movement of the insulating layer 6 in the axial direction can be effectively prevented.

Further preferably, referring to FIG. 6, the corner groove 7 may also comprise a knurling structure 80, and the insulating layer 6 is further embedded in the notches 81 of the knurling structure 80 to further strengthen the connection between the insulating layer 60 and the corner groove 7. As shown in FIG. 6, the knurling structure 80 is provided on the bottom of the corner groove 7. According to a not-shown embodiment, the knurling structures 80 may also be provided on the side surface of the corner groove 7.

FIG. 7 shows a fourth preferable embodiment of the present disclosure. Although FIG. 7 is shown with reference to the cross-sectional view of the third embodiment of FIG. 5, it should be understood that this can be a modification of any of the previously described preferable embodiments, or can be implemented separately.

Specifically, in this fourth preferable embodiment, the radial outer circumferential face 4 of the body 1 of the insulated ring may comprise an outer radial groove 41 (shown in dashed lines, substantially radially recessed). There are preferably two outer radial grooves, and the insulating layer 6 is further embedded in the outer radial grooves 41.

Further preferably, the outer radial groove 41 may also comprise a knurling structure (not shown), for example, disposed on the bottom and/or side surfaces of the outer radial groove 41, and the insulating layer 6 is further embedded in the notches of the knurling structure.

It should be understood that when such outer radial grooves 41 are formed only on the radial outer circumferential face 4 and the outer radial grooves 41 exist independently of the other grooves mentioned above, the effect of preventing axial/circumferential movement of the insulated ring can be also achieved. Therefore, the axial flange 5 and its related grooves in the aforementioned preferable embodiment can be cancelled. Therefore, the positions of the outer radial grooves 41 can be flexibly adjusted, for example, it may be disposed at the intersection part between the radial outer circumferential face 4 and the axial end face 3, like the corner groove 7 in the third preferable embodiment of FIG. 5.

In addition, since the insulated ring usually bears a certain radial force, and the radial force mainly acts on a main force-loading area in the middle of the insulated ring (as shown by the dotted ellipse in FIG. 7), therefore, if an outer radial groove 41 is arranged in the middle of the insulated ring, a larger stress concentration will be generated. Therefore, it is further preferable that the outer radial groove 41 is arranged offset along the axial direction relative to the raceway symmetry plane P (the raceway symmetry plane P is perpendicular to the axial direction X and the raceway 2 is generally symmetrical with respect to the raceway symmetry plane P), so that the outer radial groove 41 is away from the main force-loading area of the insulated ring, thereby preventing the outer radial groove 41 from adversely affecting the force-loading condition of the bearing.

In addition, since the grooves in the embodiment of FIG. 6 are arranged at the corners, so that there are no grooves on its radial outer circumferential face 4, its force-loading condition is relatively better than that in the embodiment of FIG. 7, and is more suitable for bearings that need to withstand large radial forces.

According to a further preferable modification of the present disclosure, any one of the inner radial groove 51, the axial groove 53, the corner groove 7 and the outer radial groove 41 as described above may be provided as one continuous groove or a plurality of discontinuous grooves in the circumferential direction. When a plurality of discontinuous grooves are formed (not shown), said plurality of grooves can be evenly or unevenly spaced in the circumferential direction and their number may be set and adjusted according to actual needs, and thus circumferential movement of the insulating layer can be can effectively prevented.

According to a further preferable modification of the present disclosure, in addition to providing knurling structures in various types of grooves as described above, a knurling structure (not shown), such as reticulated knurling, may be provided on at least one of the radial outer circumferential face 4 and the axial outer end face 52 of the axial flange 5, and the insulating layer 6 is further embedded in the notches of the knurling structure.

On the other hand, in the aforementioned preferable embodiments, the molded insulating layer 6 forms the outermost layer of the insulated ring. Considering the application environment of the bearing, especially when the outer ring is manufactured as an insulated ring, since the outer ring usually contacts other components (such as the housing), sometimes there may be matching and/or kinematic relationship with other components. Therefore, the insulating layer 6 formed by injection molding is not good enough to form accurate match with other components due to its poor dimensional accuracy. Moreover, during shipping of the bearing, the insulating layer 6 is also prone to undergo collision and wear, and in worst cases, insulation performance thereof is compromised.

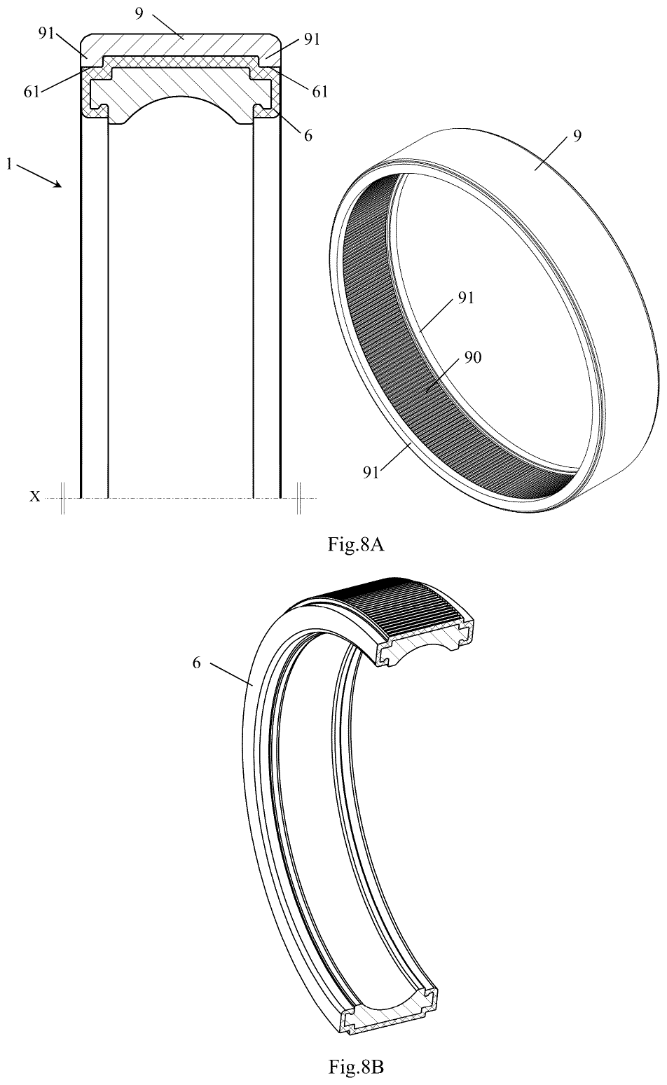

Therefore, according to a fifth preferable embodiment of the present disclosure as shown in FIGS. 8A and 8B, the present disclosure further provides that an outer metal ring 9 is provided outside the insulating layer 6. The outer metal ring 9 at least covers the radial outer face of the insulating layer 6. Preferably, the axial width of the outer metal ring 9 may be slightly larger than the axial width of the insulating layer 6.

During the manufacturing process of this insulated ring, for example, the outer metal ring 9 and the body 1 of the ring may be firstly placed in an injection mold, and then material of insulating layer 6 in liquid state is injected into the mold from an appropriate position. The outer metal ring 9 can be connected to and cover the radial outer face of the insulating layer 6 after the insulating layer 6 is molded, thereby forming an insulated ring with the outer metal ring 9. Of course, the outer metal ring 9 may be connected to and cover the radial outer face of the insulating layer 6 by any other suitable means.

Since the outer metal ring 9 is a relatively rigid component, it is easier to control the dimensional accuracy, so that the entire ring and even the entire bearing will easily meet the matching requirements with other components, and the outer metal ring 9 also provides good wear resistance and collision resistance.

Preferably, the inner surface (such as the radial inner circumferential face) of the outer metal ring 9 may also comprise a knurling structure 90, and the insulating layer 6 is further embedded in the groove of the knurling structure 90 of the outer metal ring 9 (not marked). FIG. 8B further shows the removal of the outer metal ring 9 after the insulating layer 6 is molded, to show the status of the portion of the insulating layer 6 embedded in the knurling structure 90. This embedded connection between the knurling structure 90 and the insulating layer 6 can effectively prevent radial movement between the outer metal ring 9 and the insulating layer 6.

Preferably, the outer metal ring 9 comprises a flange 91 extending radially from its outer periphery, which flange is embedded in a corner groove 61 of the insulating layer 6. With this arrangement, axial movement between the outer metal ring 9 and the insulating layer 6 can be further prevented.

Although FIGS. 8A and 8B show the addition of the outer metal ring 9 to the third preferable embodiment shown in FIG. 5, it should be understood that, according to other preferable embodiments not shown, the outer metal ring 9 can be applied to other preferable embodiments shown in FIGS. 1, 3 and 7, and will not be described and shown again.

According to the above-described preferable embodiment of the disclosure, restriction to the axial and/or circumferential movement of the insulating layer is achieved by providing “grooves” on the body of the ring, and the specific form and number of the grooves are not limited in any way. In other words, those skilled in the art will understand that the principle of the present disclosure is to increase the resistance to the axial and/or circumferential direction movement of the insulating layer by removing some material from the body of the ring and allowing the molded insulating layer to enter these material removal portions.

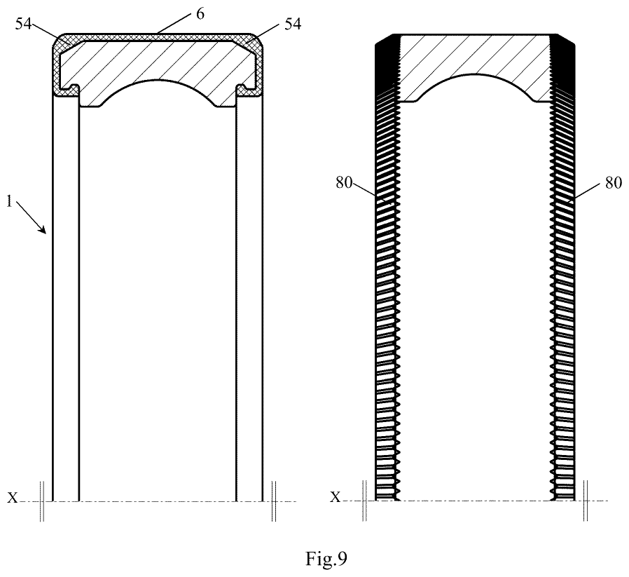

Therefore, according to another modification of the present disclosure, as shown in FIG. 9, a beveled portion(s) 54 is provided at an intersection part between the radial outer circumferential face 4 and the axial flange 5, and the insulating layer 6 can be molded into the beveled portion 54. Thereby, since this beveled portion 54 is inclined with respect to the axial direction and the radial direction, it may also provide resistance to the movement of the insulating layer 6 in the axial direction, and such resistance is same as that of the “grooves” (such as the corner groove 7) of the preferable embodiment described previously (although the beveled portion 54 differs from the specific form of the groove described previously, both of them are material removal portions). Preferably, a knurling structure 80 as previously described is also provided on the surface of this beveled portion 54 to further provide restriction to the movement of the insulating layer 6 in the circumferential direction.

In addition, the modification shown in FIG. 9 may be combined with any of the foregoing preferable embodiments as needed. For example, the beveled portion 54 may be provided in the preferable embodiment shown in FIGS. 1-2, that is, the ring can comprise both the groove 51 and the beveled portion 54 to provide a better effect of preventing axial and circumferential movement of the insulating layer 6. Further preferably, the beveled portion(s) 54 may be provided as one continuous beveled portion or a plurality of discontinuous beveled portions in the circumferential direction

Furthermore, the outer metal ring 9 shown in FIGS. 8A and 8B may be applied to the insulating layer 6 in the modification of FIG. 9, and will not be described again here.

Finally, it should be understood that, depending on different bearing structures, there are cases where the axial end face 3 coincides with the axial outer end face 52 of the axial flange 5; in other words, the ring may not comprise the axially protruding axial flange 5, but both sides of the body 1 may only comprise axial end faces 3. In this case, grooves 51 in the first preferable embodiment may not exist, so that even if only the material removal portion (such as the grooves 53, 7, 41 or the beveled portions 54) in the embodiment of FIGS. 3, 5, 7, 9 is provided, the effect of preventing axial/circumferential movement of the insulating layer 6 can be achieved too. For example, in a not-shown embodiment in which the axial flange 5 does not exist, grooves like the grooves 53 may be provided on the axial end faces 3; corner grooves such as the corner grooves 7 may be provided at the intersection parts between the axial end faces 3 and the radial outer circumferential face 4; beveled portions such as the beveled portions 54 may be provided at the intersection parts between the axial end face 3 and the radial outer circumferential face 4.

In summary, the present disclosure provides providing material removal portions (e.g., various grooves or beveled portions) on the surfaces of the body of the insulated ring (i.e., on any suitable surfaces) as long as they provide resistance to the axial/circumferential movement of the insulating layer. Further, according to the principle of the present disclosure, the above-mentioned knurling structure may be understood as a form of material removal portion too

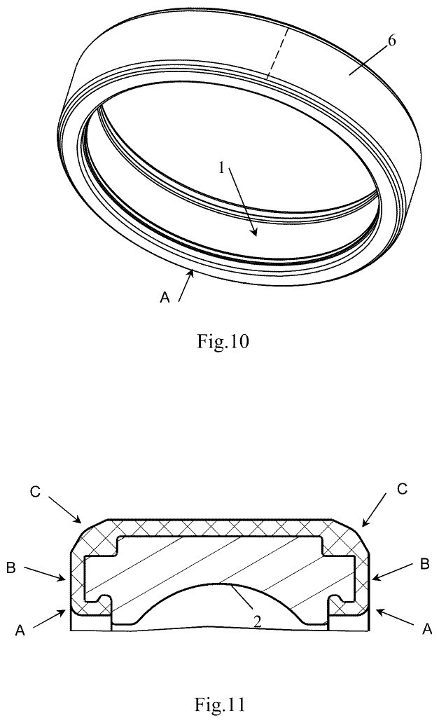

As mentioned before, in the insulated bearing of the present disclosure the insulating layer is applied on the insulated ring by overmolding, which is usually done by an injection molding machine. Referring to FIG. 10, generally speaking, if a gate used for an injection molding machine is set to inject insulating layer material centrally in the axial direction from position A, liquid insulating layer material will flow in the mold along each possible flow direction of the ring 1. Viewing from the circumferential direction, liquid insulating layer material will meet and form a weld seam at the dotted line position on the opposite side of the gate position A (i.e., a position approximately 180° symmetrical with respect to position A), that is, the weld seam will be formed in the main force-loading area of the ring. However, in general, strength of the weld seam is poor, so that formation of the weld seam in this main force-loading area adversely affects the loading and operation of the bearing, and may cause premature failure of the insulating layer itself.

Therefore, according to another aspect of the present disclosure, the present disclosure also provides a method of manufacturing an insulated bearing. This method is mainly optimized for the gate position used for the injection molding machine for overmolding the insulating layer, so that the weld seam of the overmolded insulating layer 6 avoids the main force-loading area of the insulated ring and/or formed at a position where thickness of the insulating layer 6 is maximum.

For example, referring to FIG. 11 (with reference to a cross-sectional view of the third preferable embodiment) and FIGS. 1, 3, 5, 7 and 9, according to the method of the present disclosure, the gate used for the injection molding machine may be placed at a plurality of positions: for example, a gate may be placed substantially facing the inner circumferential face 50 of the axial flange 5, as indicated by arrow A, which is more suitable for the first preferable embodiment of FIG. 1; a gate may be placed facing the axial outer end face 52 of the axial flange 5, as shown by arrow B, which is more suitable for the second preferable embodiment of FIG. 3 and the fifth preferable embodiment of FIGS. 8A and 8B; a gate may be placed facing the intersection part between the radial circumferential face 4 and the axial flange 5, as shown by arrow C, which is more suitable for the third preferable embodiment of FIG. 5, the third preferable embodiment of FIG. 7 and the four preferable embodiments and modifications of FIG. 9.

Of course, it should be understood that although preferable gate positions are set forth above for various preferable embodiments, this is not a limitation. Depending on actual needs, the gate positions described above may be used in other preferable embodiments. According to actual needs, it is also possible to select a plurality of positions from the above-mentioned positions to provide a plurality of gates for a certain preferable embodiment.

Finally, although not shown, those skilled in the art will understand that the inner and outer rings of the bearing are arranged on both sides of the rolling elements, and the inner ring has a substantially symmetrical structure with the outer ring. For example, the inner ring also includes a raceway, an axial end face, a radial outer circumferential face (which is opposite to the inner ring raceway and usually faces the rotating shaft), etc. Therefore, the inner ring may also similarly include various types of grooves described in the above preferable embodiment for retaining the insulating layer, and/or an outer metal ring connected to and covering the insulating layer of the inner ring (which may be in contact with the rotating shaft), which will not be described in detail here. That is to say, the “insulated ring” of the present disclosure can be the outer ring of the bearing or the inner ring of the bearing, as long as it implements the principle of the present disclosure.

In summary, the present disclosure provides an insulated bearing and a manufacture method thereof in order to solve the problem of electrical corrosion of bearings used in high-voltage environments. The present disclosure not only achieves good electrical insulation for the bearing, but also further prevents axial and/or circumferential movement of the insulating layer, greatly improving the electrical performance and life of the insulating layer as well as the entire bearing.

The exemplary embodiments of the present disclosure have been described in detail above with reference to preferable embodiments. However, those skilled in the art will understand that various modifications and modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

1. An insulating bearing comprising:
an outer ring;
an inner ring; and
rolling elements arranged between the outer ring and the inner ring;
at least one of the outer ring and the inner ring is configured as an insulated ring comprising a body and an insulating layer overmolded on a surface of the body the insulating layer having a dielectric constant lower than 5 @ 1 MHz.

2. The insulated bearing according to claim 1, wherein the dielectric constant of the insulating layer is lower than 4 @ 1 MHz.

3. The insulated bearing according to claim 1, wherein the dielectric constant of the insulating layer is lower than 3.5 @ 1 MHz.

4. The insulated bearing according to claim 1, wherein the insulating layer is formed by a polymer, said polymer being polyphenylene sulfide, or aromatic nylon.

5. The insulated bearing according to claim 1, wherein the insulating layer is formed by a polymer alloy comprising a continuous phase and a dispersed phase, wherein preferably the continuous phase of the polymer alloy is polyphenylene sulfide, or aromatic nylon, or a mixture of polyphenylene sulfide and aromatic nylon; preferably, in the polymer alloy, the content of the continuous phase is 20-70 wt %.

6. The insulated bearing according to claim 5, wherein when the continuous phase comprises polyphenylene sulfide, the polyphenylene sulfide is linear polyphenylene sulfide and/or cross-linked polyphenylene sulfide.

7. The insulated bearing according to claim 5, wherein said dispersed phase is polyphenylene ether; preferably, in the polymer alloy, the content of the dispersed phase is 5-25 wt %.

8. The insulated bearing according to claim 4, wherein the insulating layer further comprises glass fibers, and preferably the glass fibers are E-glass fibers, D-glass fibers and/or quartz glass fibers; further preferably, in the insulating layer, the content of the glass fibers is 20-60 wt %.

9. The insulated bearing according to claim 4, wherein the insulating layer further comprises a thermal conductive material, and preferably said thermal conductive material is one or more of hexagonal boron nitride, Al₂O₃, AlN, BeO, Si₃N₄, MgO and SiO₂; further preferably, in the insulating layer, the content of the thermal conductive material is 20-60 wt %.

10. The insulated bearing according to claim 5, wherein the insulating layer further comprises glass fibers, and preferably the glass fibers are E-glass fibers, D-glass fibers and/or quartz glass fibers; further preferably, in the insulating layer, the content of the glass fibers is 20-60 wt %.

11. The insulated bearing according to claim 5, wherein the insulating layer further comprises a thermal conductive material, and preferably said thermal conductive material is one or more of hexagonal boron nitride, Al₂O₃, AlN, BeO, Si₃N₄, MgO and SiO₂; further preferably, in the insulating layer, the content of the thermal conductive material is 20-60 wt %.

12. The insulated bearing according to claim 1, wherein the insulating layer is formed by a polymer alloy comprising 20-70 wt % of a continuous phase, 5-25 wt % of a dispersed phase, 20-60 wt % of glass fibers, the remainder being thermal conductive material;
preferably, the continuous phase is polyphenylene sulfide, or aromatic nylon, or a mixture of polyphenylene sulfide and aromatic nylon;
preferably, the dispersed phase is polyphenylene ether;
preferably, the glass fibers are E-glass fibers, D-glass fibers and/or quartz glass fibers;
preferably, the thermal conductive material is one or more of hexagonal boron nitride, Al₂O₃, AlN, BeO, Si₃N₄, MgO and SiO₂.

13. The insulated bearing according to claim 1, wherein the body further comprises:
a raceway;
an axial end face;
a radial outer circumferential face, disposed radially away from the raceway;
wherein a surface of the body comprises a material removal portion, and an insulating layer is overmolded on the body and molded into the material removal portion;
preferably:
the body comprises an axial flange projecting axially outward with respect to said axial end face and having a beveled portion as said material removal portion at the intersection part between said radial outer circumferential face and said axial flange; or
the body further comprises a beveled portion as the material removal portion provided at the intersection part between the radial outer circumferential face and the axial end face.

14. A method of manufacturing an insulated inner or outer ring for an insulated bearing, the method comprising:
overmolding an insulating layer onto a body, said overmodling including arranging a gate of an injection molding machine so that the weld seam of the insulating layer after overmolding avoids the main force-loading area of the insulated ring and/or is formed in the insulating layer where the thickness of the insulating layer is at a maximum, the insulating layer having a dielectric constant lower than 5 @ 1 MHz.

15. The method of claim 14, wherein said arranging comprises arranging the gate of the injection molding machine so that the weld seam of the insulating layer after overmolding avoids the main force-loading area of the insulated ring.

16. The method of claim 14, wherein said arranging comprises arranging the gate of the injection molding machine so that the weld seam of the insulating layer after overmolding is formed in the insulating layer where the thickness of the insulating layer is at a maximum.
